(19) United States
(12) Patent Application Publication
(10) Pub. No.: US 2009/0242037 A1
(43) Pub. Date: Oct. 1, 2009

(54) FUEL DELIVERY SYSTEM FOR A TORCH

(76) Inventor: William T. Drescher, Milford, NH (US)

Correspondence Address: LANDO & ANASTASI, LLP, ONE MAIN STREET, SUITE 1100, CAMBRIDGE, MA, 02142, US

(21) Appl. No.: 12/407,179

(22) Filed: Mar. 19, 2009

Related U.S. Application Data
(60) Provisional application No. 61/039,913, filed on Mar. 27, 2008.

(51) Int. Cl. F15C 4/00; F23D 14/28

(52) U.S. Cl. 137/14; 431/344

(57) ABSTRACT

A fuel delivery system for a torch comprising a first container configured to contain a reactant gas under pressure, a second container configured to contain a combustible substance under ambient pressure, and a third container configured to contain a propellant gas under pressure, the third container being in fluid communication with the second container to selectively pressurize the second container.

### RELATED APPLICATIONS

This application claims priority under 35 U.S.C. §119(e) to U.S. Provisional Application No. 61/039,913, entitled “A Fuel Delivery System For A Torch”, filed Mar. 27, 2008, which is hereby incorporated by reference in its entirety for all purposes.

### BACKGROUND

1. Field of the Invention

The present disclosure relates generally to a system for delivering fuel to a torch, and more particularly to a fuel delivery system that employs a propellant gas to propel a combustible fuel source, and a structure for separating and delivering the combustible fuel source and a reactant gas to the torch.

2. Description of the Related Art

The use of oxy-fuel flames remains one of the most widely used forms of cutting and heating sources today. A relatively compact system consisting of an oxygen and fuel gas cylinder may be transported easily. Such gasses can deliver very high levels of BTUs on demand at an economical cost. Some commonly used gasses for these processes include oxy acetylene, methylacetylene-propadiene (sold under the trade name MAPP® by the Dow Chemical Company of Midland, Mich.), propane, and propylene. Such gasses have neutral flame temperatures ranging from 4600 to 5600° F. and can produce heat that ranges from 1000 to 2500 BTU/ft³.

There are drawbacks associated with using these gasses, however. For example, acetylene, the most commonly used gas, is unstable at pressures above 30 psi or at temperatures above 1435° F. Acetylene may explode without the presence of oxygen if subjected to high temperatures, electrical sparks or physical shock. To make this gas safer, acetylene may be dissolved into acetone and stored in a cylinder.

Gases such as MAPP®, propylene, and propane, are less dangerous as their explosive limits are much safer. It takes a narrower window of oxygen mixture to support combustion, and these gases are much less likely to accidentally explode. These gases are typically stored in liquid form in pressurized tanks. This makes storage and delivery of such materials much more labor intensive than fuel that remains liquid at room temperature, such as gasoline. In addition, gasoline is less expensive and more widely available than many of the gasses traditionally used with torches.

The use of gasoline represents an opportunity in the market, but suffers from potential hazards. For example, the use of pressurized ambient air to move the liquid gasoline to the torch may create a volatile mixture as the fuel storage tank empties. Specifically, the volume of pressurized air and gasoline vapor creates a volatile mixture, thereby increasing the potential of an explosion off the mixture.

Conventional fuel delivery systems thus present several disadvantages. Several are described in the following patents, none of which are admitted to be prior art with respect to the present disclosure by their mention in this section.

U.S. Pat. No. 3,103,238 and U.S. Pat. No. 6,966,768 describe systems in which oxygen is provided from the ambient air, the fuel is delivered as a liquid stream, and the fuel may be consumed within a matter of minutes.

U.S. Pat. No. 3,844,449 describes a multiple purpose dispenser.

U.S. Pat. No. 7,252,297 describes liquid fuels that vaporize under normal atmospheric conditions such as MAPP gas, propylene, natural gas and propane.

U.S. Pat. No. 4,625,949 describes a way of storing cutting and welding accessories conveniently.

U.S. Pat. No. 4,573,665 describes a cart adapted to store and transport the articles necessary to carry out the operation of an oxygen lance or burning bar setup.

U.S. Pat. No. 7,122,147 describes an emergency cutting torch.

### SUMMARY

One aspect of the disclosure is directed to a fuel delivery system for a torch comprising a first container configured to contain a reactant gas under pressure, a second container configured to contain a combustible substance under ambient pressure, and a third container configured to contain a propellant gas under pressure, the third container being in fluid communication with the second container to selectively pressurize the second container. In one embodiment, the combustible substance is gasoline and the propellant is an inert gas.

Embodiments of the system may further include a hub configured to receive the reactant gas from the first container through a first line and the combustible substance from the second container through a second line. In a certain embodiment, the hub comprises a first passage configured to receive the reactant gas from the first line and a second passage configured to receive the combustible substance from the second line. The system may further comprise a hose and torch connected to the hub.

Another aspect of the disclosure is directed to a method of delivering a reactant gas and a combustible substance to a torch, the method comprising storing the reactant gas within a first container under pressure, delivering the reactant gas to the torch through a first line, storing combustible substance within a second container, pressurizing the second container with inert fluid contained within a third container in fluid communication with the second container, the third container being configured to store the inert fluid under pressure, and delivering the combustible substance to the torch through a second line, wherein the rate of delivery of the combustible substance to the torch is controlled by manipulating the pressure of the third container.

Embodiments of the system may further comprise a pressure regulator to control the pressure of the third container. Further, a pressure regulator may be provided to control the pressure of the first container.

Another aspect of the disclosure is directed to a method of delivering a reactant gas and a combustible substance to a torch, the method comprising storing the reactant gas within a first container, delivering the reactant gas to a hub, storing combustible substance within a second container, delivering the combustible substance to the hub, separating the reactant gas and the combustible gas within the hub, and delivering the reacting gas and the combustible gas to a torch. Embodiments of the system may further comprise pressurizing the second container with inert fluid contained within a third container in fluid communication with the second container, the third container being configured to store the inert fluid under pressure. In a certain embodiment, the rate of delivery of the combustible substance to the torch is controlled by manipulating the pressure of the third container.

### BRIEF DESCRIPTION OF THE DRAWINGS

Various aspects of at least one embodiment are discussed below with reference to the accompanying figures. In the figures, which are not intended to be drawn to scale, each identical or nearly identical component that is illustrated in various figures is represented by a like numeral. For purposes of clarity, not every component may be labeled in every drawing. The figures are provided for the purposes of illustration and explanation and are not intended as a definition of the limits of the disclosure. In the figures:

FIG. 1 is a schematic view of a fuel delivery system with a source of reactant gas;

FIG. 2A is a cross-sectional view of one example of a hose reel hub assembly for delivering reactant gas and a combustible substance taken along sectional line 2A-2A in FIG. 8;

FIG. 2B is a cross-sectional view of the hose reel hub assembly taken along a sectional line 2B-2B in FIG. 2A;

FIG. 3 is a front view of an embodiment of a fuel delivery system shown with the source of reactant gas being illustrated by its outline only;

FIG. 4 is a rear view of the fuel delivery system shown in FIG. 3;

FIG. 5 is a left side view of the fuel delivery system shown in FIG. 3;

FIG. 6 is a front view of the fuel delivery system show in FIG. 3;

FIG. 7 is a cross-sectional view of one example of a hose reel hub assembly; and

FIG. 8 is a top plan view of the fuel delivery system shown in FIG. 3.

### DESCRIPTION

For purposes of illustration, embodiments of the present disclosure will now be described with reference to a fuel delivery system for a torch. One skilled in the art, however, will realize that the embodiments of the present disclosure are not limited to the field of fuel delivery systems, but rather may be used in any field requiring the delivery through pressure or other applied method of at least one fluid through at least one passage. Thus, it is to be appreciated that embodiments of the methods and apparatuses discussed herein are not limited in application to the details of construction and the particular arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

Certain examples of the systems disclosed herein will be recognized by the person of ordinary skill in the art, given the benefit of this disclosure, of an improved fuel delivery system for a torch. In certain embodiments, an economical combustible substance, including but not limited to gasoline, may be selectively pressurized to deliver the combustible substance to a torch. In some embodiments, a reel structure may be employed that separately delivers the combustible substance and a reactant gas to a torch.

The fuel delivery systems for a torch of certain examples disclosed herein may improve the safety and cost-effectiveness of applications involving a torch, and may reduce the risk of explosions associated with prior fuel delivery systems. The current manufacturing process for fuel delivery systems may be adapted to include the teachings of the present disclosure, with reduced, minimal or no additional cost.

In one embodiment, a system may be configured to include a first container configured to contain a reactant gas under pressure, a second container configured to contain a combustible substance under ambient pressure, and a third container configured to contain a propellant gas under pressure, the third container being in fluid communication with the second container to selectively pressurize the second container.

In another embodiment, a system may be configured to include a torch, a hose connected to and in fluid communication with the torch, a hub connected to and in fluid communication with the hose, a first container configured to contain a reactant gas under pressure, the first container being connected to and in fluid communication with the hub, and a second container configured to contain a combustible substance, the second container being connected to and in fluid communication with the hub and selectively pressurized to deliver the combustible substance to the hub under pressure.

In yet another embodiment, a method of delivering a reactant gas and a combustible substance to a torch may include storing the reactant gas within a first container under pressure, delivering the reactant gas to the torch through a first line, storing combustible substance within a second container, pressurizing the second container with inert fluid contained within a third container in fluid communication with the second container, the third container being configured to store the inert fluid under pressure, and delivering the combustible substance to the torch through a second line, wherein the rate of delivery of the combustible substance to the torch is controlled by manipulating the pressure of the third container.

In another embodiment, a method may include storing the reactant gas within a first container, delivering the reactant gas to a hub, storing combustible substance within a second container, delivering the combustible substance to the hub, separating the reactant gas and the combustible gas within the hub, and delivering the reacting gas and the combustible gas to a torch.

The system may include a source of fuel, such as a container, tank, or other storage device capable of holding a combustible fuel. Although the term “container” or “tank” is used through this specification, it would be readily understood by one of ordinary skill in the art that this may include a source of fuel that is external to the system and may be delivered by a conduit or other conveyance. The source may be stored under positive pressure, ambient pressure, or may be pumped. The fuel may be a petroleum-based fuel such as gasoline, or it may be any other suitable combustible fuel.

The fuel container may be in communication with a source of fluid propellant, such as a container, tank, or other storage device capable of holding a fluid propellant. Although the term “container” or “tank” is used through this specification, it would be readily understood by one of ordinary skill in the art that this may include a source of propellant that is external to the system and may be delivered by a conduit or other conveyance. The source of fluid propellant may be stored under positive pressure, ambient pressure, or may be pumped. The fluid propellant may be a gas, preferably an inert gas or relatively non-reactive gas, such as carbon dioxide, nitrogen, argon, or any other non-flammable gas.

The fluid propellant may be controllably introduced into the fuel container in order to pressurize the fuel container. This may have the effect of directing the combustible fuel into a fuel line for eventual delivery to a torch. By manipulating the rate at which the fluid propellant is introduced into the fuel container, the amount of combustible fuel delivered to the torch can be accurately controlled.

Before reaching the torch, the fuel line may communicate with and be wrapped around a hose reel for purposes of storage and preventing kinks in the fuel line. The fuel line may communicate with the hose reel through the use of a live swivel connector, enabling the hose reel to spin freely when the fuel line is being rolled out from or onto the hose reel.

The system may also include a source of reactant gas, such as a container, tank, or other storage device capable of holding a reactant gas. Although the term “container” or “tank” is used through this specification, it would be readily understood by one of ordinary skill in the art that this may include a source of reactant that is external to the system and may be delivered by a conduit or other conveyance. The source of reactant gas may be stored under positive pressure, ambient pressure, or may be pumped. The reactant gas may be any gas that can react with fuel and result in combustion, for example, air or oxygen.

The source of reactant gas may be in communication with a reactant line, allowing the reactive gas to be similarly directed into a reactant line for eventual delivery to a torch. In a manner similar to the fuel line, the reactant line before reaching the torch may communicate with and be wrapped around a hose reel for purposes of storage and preventing kinks in the line. The reactant line may communicate with the hose reel through the use of a live swivel connector, enabling the hose reel to spin freely when the reactant line is being rolled out from or onto the hose reel. Thus, both the fuel line and the reactant line may be coiled and stored separately on the hose reel.

The communication among the various sources and between the sources and the torch may be achieved through the use of a series of conduits or tubes, for example hoses, that may deliver the fluids in the system to other parts of the system.

It will be within the ability of the person of ordinary skill in the art, given the benefit of the disclosure, to select or design suitable materials of construction of the storage and delivery mechanisms disclosed herein.

The fuel delivery system in a particular embodiment may be used in conjunction with a gasoline cutting torch. An embodiment of such a gasoline cutting torch may further include a support and mobility system such as a cart that contains several features of the torch system. Such an embodiment may include a single hose capable of delivering reactant and fuel through separate channels to the torch. The embodiment may further include a built-in hose reel, and it may incorporate and/or retain separate containers for holding a reactant gas, a combustible fuel, and a fluid propellant. The system in this embodiment operates by pressurizing the combustible fuel, for example gasoline, thereby causing it to travel through a fuel line to the torch, where it may be vaporized. The reactant line simultaneously delivers reactant gas to the torch. When the torch is thus provided with the reactant gas and the vaporized combustible fuel it may be capable of supporting a self-sustaining flame similar to those found in the oxy-fuel flame torches currently known and used in the art. The cart in the described embodiment may have a wheel base designed to be advantageous in the work environment where the torch and cart are used. A mechanism for extending the legs of the cart or otherwise elevating it to perform work at a higher distance above the ground is also contemplated. The cart may further be configured to be mounted to a vehicle or inside the bed of a truck, for example. The cart may further be configured to include a storage device for storing accessories such as spark lighters, eye goggles, tip cleaning tools, various sized tips, or other work or safety gear. It will be within the ability of the person of ordinary skill in the art, given the benefit of the disclosure, to select or design suitable materials of construction of the cart and storage and delivery mechanisms disclosed herein.

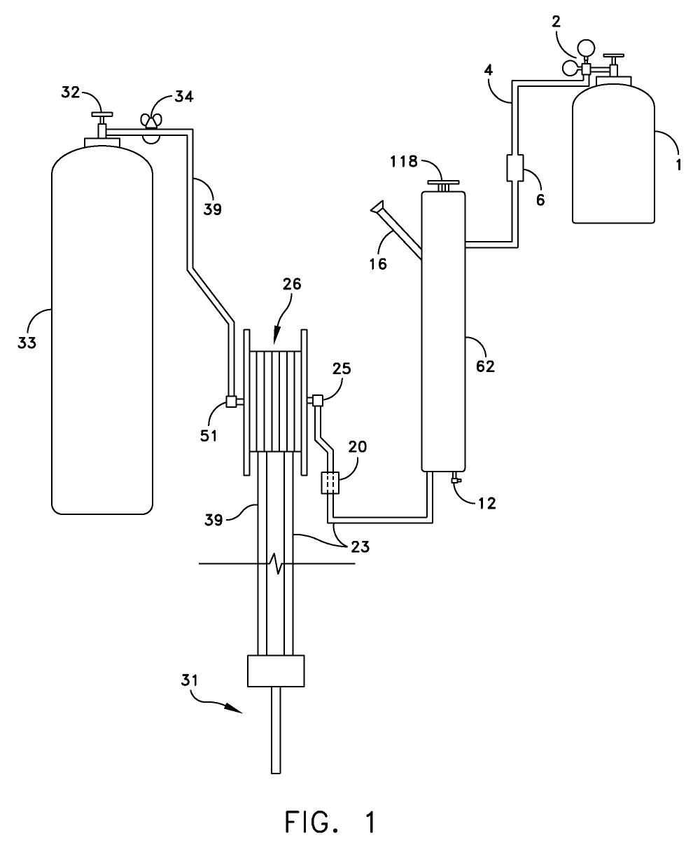

Referring to FIG. 1, a schematic of one embodiment of the improved fuel delivery system can be seen. A fuel tank 62 contains a quantity of combustible substance, for example, a petroleum-based fuel such as gasoline. The fuel tank 62 is in fluid communication with a propellant tank 1, which contains a quantity of fluid propellant, for example, an inert or relatively non-reactant gas such as carbon dioxide, nitrogen, or argon. Propellant travels from the propellant tank 1 through a propellant line 4, which is a hose or other conduit capable of conveying pressurized propellant through its length. One or both of the propellant tank 1 and the propellant line 4 may have a propellant regulator 2, which can be manipulated by hand or by an automated device to control the amount of propellant entering the fuel tank 62. Additionally, a propellant check valve 6 is in fluid communication with the propellant line 4. The propellant check valve 6 is configured to allow propellant to flow through the propellant line 4 in a direction from the propellant tank 1 to the fuel tank 62, but to prevent backflow of propellant or fuel into the propellant tank 1.

Propellant enters the fuel tank 62 through the propellant line 4, thereby creating a positive internal pressure in the fuel tank 62. The fuel tank 62 has a fuel cap 16 that is removable or otherwise provides access to the inside of the tank for refilling or maintenance purposes. The fuel tank 62 may further incorporate a pressure relief valve 118 calibrated to avoid over-pressurization situations by releasing pressure from inside the fuel tank 62 when a preset threshold pressure is reached. The fuel tank 62 also incorporates a drain cock 12, allowing the fuel tank 62 to be emptied for storage or maintenance.

The pressure generated in the fuel tank 62 by the introduction of propellant from propellant tank 1 has the effect of pushing the fuel through a fuel line 23 for eventual delivery to a torch 31. The fuel line 23 may be a hose or other conduit suitable for conveying fuel to the torch 31. The fuel line 23 may incorporate a fuel filter 20 for filtering particulate matter from the fuel. The fuel filter 20 may be removable or displaceable for cleaning or replacement purposes. The torch 31 is configured to vaporize the fuel and produce a directed mist of fuel. When the fuel is mixed with a reactant gas, the mist may be ignited through the use of a welding spark lighter (not shown) or other known techniques of generating ignition. This will create a self-sustaining flame, which may be used for cutting or heating. The intensity of the flame may be controlled or the flame may be extinguished by varying the amount of fuel delivered to the torch 31. This may be controlled by manipulating the propellant regulator 2, which regulates the amount of propellant entering the fuel tank 62 from propellant tank 1, and therefore determines the pressure in fuel tank 62.

Referring still to FIG. 1, a reactant tank 33 is provided, the tank containing a quantity of reactant gas that can react with fuel and result in combustion. Typical examples of reactant gas include air and oxygen. As reactant gas is typically stored under positive pressure, the reactant tank 33 is therefore obtained from a local welding gas supplier. The reactant tank 33 has a reactant cap 32 that is removable or otherwise provides access to the inside of the tank for refilling or maintenance purposes. The reactant cap 32 is of a configuration and construction to withstand the pressure encountered inside the reactant tank 33.

Due to the pressure inside the reactant tank 33, reactant gas is forced through a reactant line 39 in fluid communication with the reactant tank 33 for eventual delivery to the torch 31. One or both of the reactant tank 33 and the reactant line 39 may have a reactant regulator 34, which can be manipulated by hand or automated device to control the amount of reactant being delivered to the torch 31. As described above, the reactant gas mixes with the directed mist of fuel from fuel tank 62 to create a combustible mixture which can be ignited to create a self-sustaining flame.

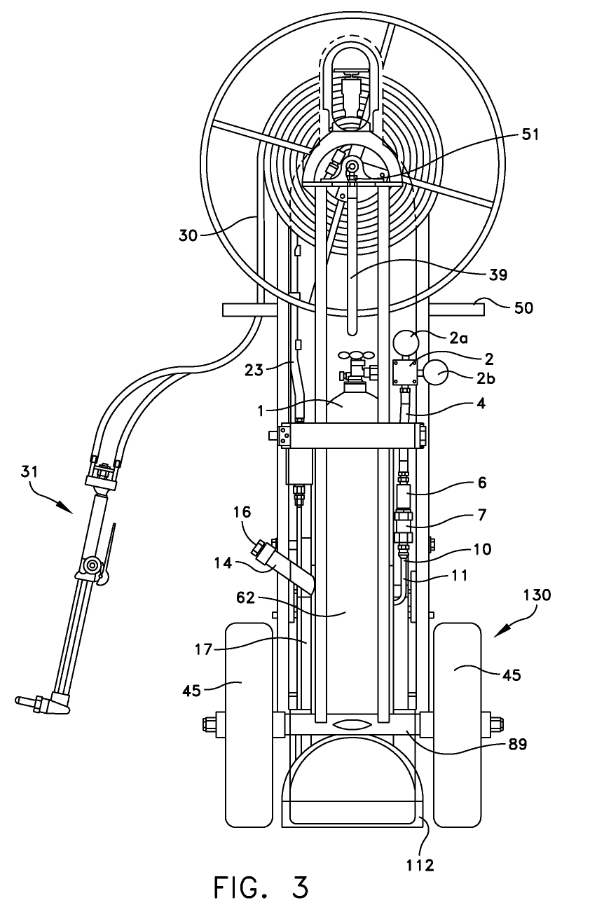

With continued reference to FIG. 1, the fuel line 23 and reactant line 39 may be encased in separate protective conduits or hoses for their entire length and may be separately connected to the torch 31. In another embodiment, as seen for example in FIG. 3, the fuel line 23 and the reactant line 39 are encased together for at least some of their length in a welding hose 30. Such welding hoses are known in the art in various configurations, for example a 50 foot type-T ¼″ standard oxy-gas welding hose. Both configurations will be used herein for purposes of example, though it will be understood that any configuration will be acceptable so long as it maintains the physical and fluid separation between the fuel and reactant until they reach the torch 31.

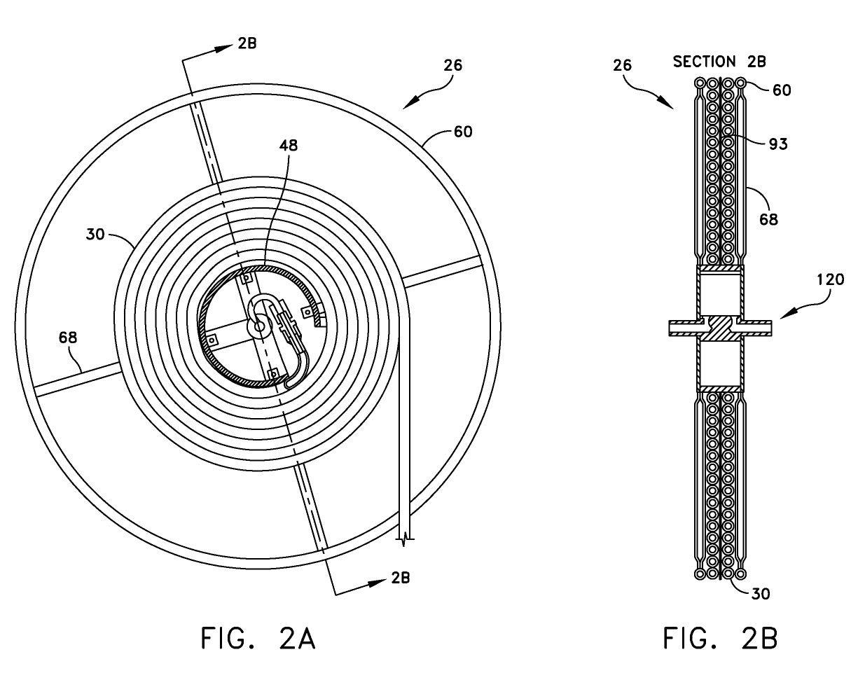

In a certain embodiment, a hose reel 26 as seen in FIGS. 1, 2A, and 2B is rotatably mounted to retain and store the welding hose 30 in a coiled orientation to prevent kinks. The hose reel 26 rotates around an axle, thereby spooling or unspooling the welding hose as needed. The fuel line 23 and the reactant line 39 each fluidly communicate with the hose reel 26 at the axle of the hose reel 26, and the two lines, while fluidly separated, may become sheathed together in a welding hose 30, as seen in FIG. 3 and described above.

It is desirable to prevent torque from acting on the connection between the fuel line 23 and the hose reel 26, or the connection between the reactant line 39 and the hose reel 26, when the hose reel 26 is rotating. Therefore, in a particular embodiment live swivel connectors 25 and 51 are used to connect fuel line 23 and reactant line 39, respectively, in fluid communication with hose reel 26 while allowing hose reel 26 to rotate freely.

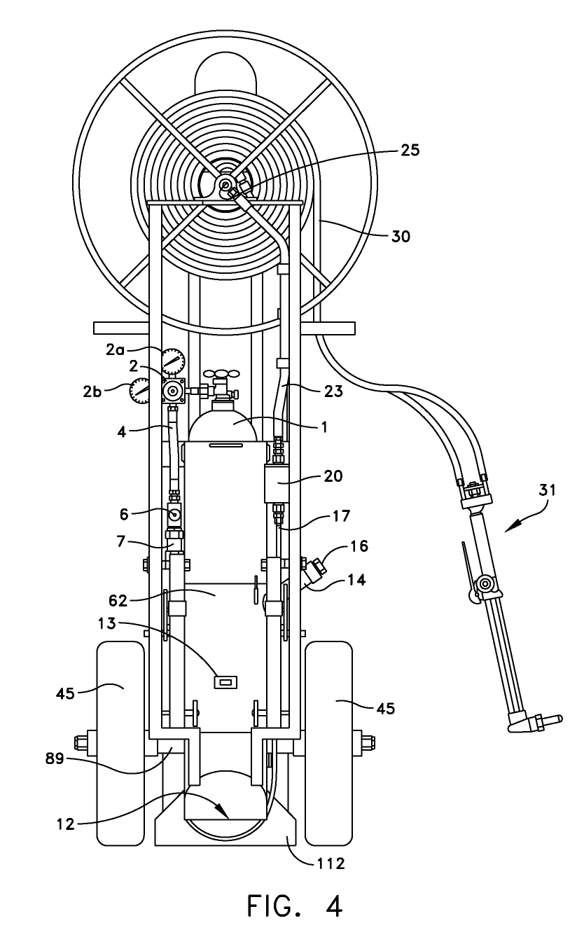

FIGS. 3 and 4 show the propellant tank 1, the fuel tank 62, and the fluid communication therebetween of one particular embodiment in more detail. The propellant tank 1 in this embodiment is represented as a 5 pound carbon dioxide tank, although any suitable container having any suitable propellant may be used. The propellant tank 1 is shown having a shouldered top with a port or opening at the top allowing it to fluidly communicate with a propellant regulator 2, which in this embodiment may be a particular type of regulator designed for use with carbon dioxide, for example, the type available through welding or industrial suppliers such as McMaster-Carr of Elmhurst, Ill. The propellant regulator 2 is sealably mounted on the propellant tank 1 in such a way that propellant may not exit the propellant tank 1 except through the port communicating with the propellant regulator 2. The propellant regulator 2 may be a cryogenic regulator as is commonly known in the art. The propellant regulator 2 is equipped with a mechanism for controlling the rate at which propellant is allowed to exit the propellant tank 1, for example, a manual or automated valve. The propellant regulator 2 may be configured to maintain a constant output pressure as the volume of propellant in the tank decreases. A set screw (not shown) may also be provided to allow the pressure to be set at a predetermined level. For example, the pressure may be preset at 35 psi for atmospheric usage or at 100 psi for underwater cutting.

Propellant regulator 2 may also be equipped with a mechanism for providing information about the conditions inside of the propellant tank 1, the flow into the propellant regulator 2, and the flow out of the propellant regulator 2, as shown by dials 2a and 2b. It will be appreciated that any analog or digital display may also be used.

As best seen in FIG. 4, the propellant regulator 2 is in fluid communication with the propellant line 4, and may be sealably attached thereto with a crimp fitting or other suitable mechanism. The propellant line 4 may be a durable hose of any suitable length, rated for high pressure and being resistant to hydrocarbon fuels. A flexible hose may be of particular utility in that it may be manipulated to couple with the propellant regulator 2 without requiring the propellant regulator 2 to be oriented in any particular direction. A rigid pipe may be undesirable in that it would require the propellant regulator 2 and therefore the propellant tank 1 to be precisely oriented in a specific direction in order to couple with propellant line 4. The propellant line 4 incorporates in fluid communication a propellant check valve 6, which is configured to allow propellant to flow through the propellant line 4 in a direction from the propellant tank 1 to the fuel tank 62, but to prevent backflow of propellant or fuel into the propellant tank 1. The propellant check valve 6 is sealably connected to the propellant line 4 with a crimp fitting or other suitable mechanism.

Prior to entering the fuel tank 62, the propellant also passes through a pressure relief valve 7, which prevents over-pressurization situations in the fuel tank 62 by diverting some propellant from the system when the pressure in the propellant line 4 exceeds a certain preset threshold, for example, 150 psi. The pressure relief valve 7 may be placed down the propellant stream from the propellant check valve 6 in order to prevent failure or stress of the propellant check valve 6 or other components such as hoses or fittings in the event of an over-pressurization situation.

As can be seen in FIG. 3, the pressure relief valve 7 is connected to a length of rigid tubing 11 by an adapter 10. This configuration places the pressure relief valve 7 in fluid communication with the rigid tubing 11, which in turn is in fluid communication with the fuel tank 62. The rigid tubing 11 is relatively thick-walled, for example steel drawn-over-mandrel (DOM) tubing that is rated for high pressure. The propellant then enters the fuel tank 62.

The fuel tank 62 in this embodiment is of a rigid metal construction, for example a steel tube having dimensions ¼ inch×4 inch×53 inch and a volume of approximately two gallons. However, in a situation where weight or other factors are an issue suitable alternative materials or construction may be used provided it is capable of withstanding the positive pressures experienced when the propellant is introduced. The fuel tank 62 contains a quantity of a petroleum-based fuel, for example gasoline, that may be stored at ambient or slightly greater than ambient pressure. The fuel tank 62 incorporates a fuel filler pipe 14 having a fuel cap 16. The fuel cap 16 may be displaced or removed to facilitate refueling of the fuel tank 62 or visual inspection of its contents through the fuel filler pipe 14. The pressure relief valve 7 may be placed at a height above the fuel cap 16. This is advantageous in an over-pressurization situation, in that the fuel will spill out the fuel filler pipe 14 before backing up to the pressure relief valve 7 in propellant line 4, possibly causing damage to either component.

As seen in FIG. 4, the fuel tank 62 is equipped with at least one level gauge 13 for displaying the level of fuel in the tank. The level gauge 13 may connected to a float switch (not shown) for detecting the level of fuel in the fuel tank 62, and may incorporate a dial or any other analog or digital display. Additionally, a drain cock 12 is provided at the bottom of the fuel tank 62 to allow for drainage of the fuel when desired for maintenance or storage.

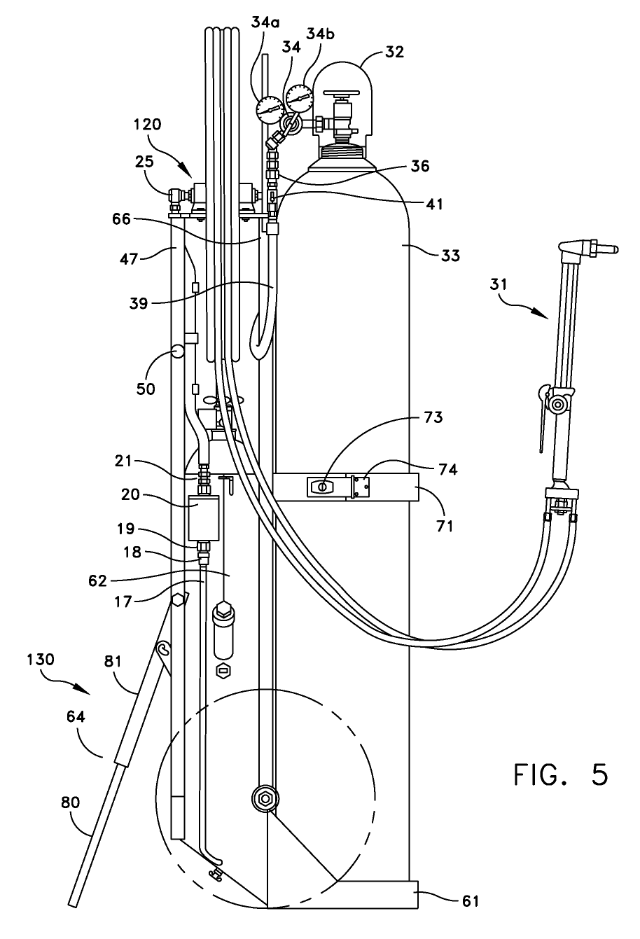

In a particular embodiment as best seen in FIG. 5, the pressure created in the fuel tank 62 by the introduction of propellant causes fuel to exit the bottom of the fuel tank 62 through rigid tubing 17. The rigid tubing 17 may be relatively thick-walled, for example steel drawn-over-mandrel (DOM) tubing that is rated for high pressure. As shown, the system may further incorporate a fuel filter 20, which serves to screen or otherwise filter out undesirable particulate matter from the fuel. The fuel filter 20 is connected in fluid communication with the rigid tubing 17 through adapters 18 and 19. The fuel filter is also connected in fluid communication with a fuel line 23 through an adapter 21. The fuel line 23 may be constructed of flexible material, which may be desirable in this situation in that it allows easy removal or replacement of the fuel filter 20 for cleaning and/or maintenance. In one particular embodiment (not shown), the fuel line 23 is directly coupled in fluid communication with the torch 31 through a threaded adapter (not shown) or other connection structure. In an alternative embodiment that will be discussed in more detail below, the fuel line 23 may be fitted with a live swivel connector 25 to allow it to remain fluidly connected with a hose reel 26 while the hose reel 26 rotates on an axis.

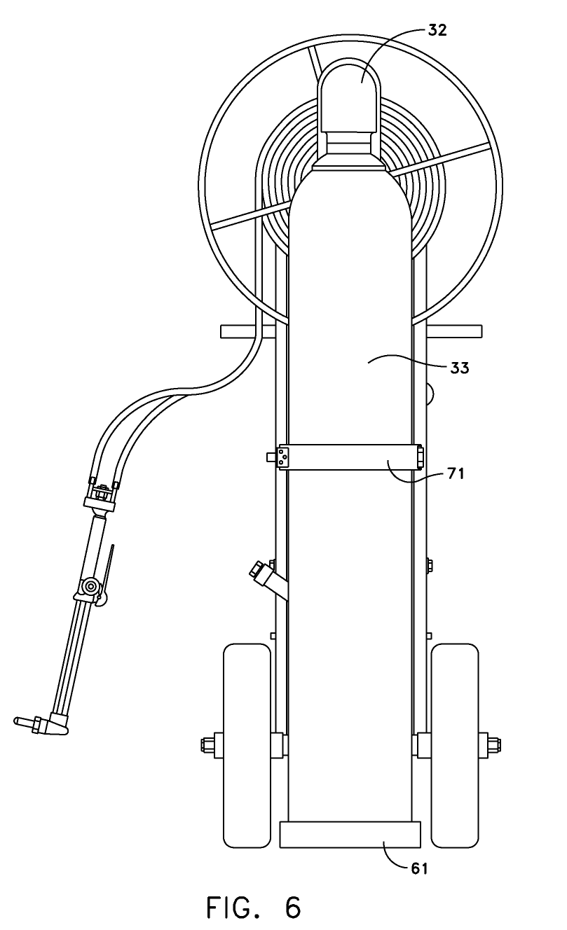

Referring to FIGS. 5 and 6, the reactant tank 33 of one particular embodiment can be seen in detail. The reactant tank 33 in this embodiment is represented as a 300 cubic foot capacity oxygen (O₂) tank, although any suitable container having any suitable reactant may be used. The reactant tank 33 is shown having a shouldered top with a port or opening at the top allowing it to fluidly communicate with a reactant regulator 34, which in this embodiment may be a particular type of regulator designed for use with oxygen. The reactant regulator 34 is sealably mounted on the reactant tank 33 in such a way that propellant may not exit the reactant tank 33 except through the port communicating with the reactant regulator 34.

The reactant regulator 34 may be a two stage regulator as is known in the art. The reactant regulator 34 is equipped with a mechanism for controlling the rate at which reactant is allowed to exit the reactant tank 33, for example a manual or automated valve. The reactant regulator 34 may be configured to maintain a constant output pressure as the volume of reactant in the tank decreases. For example, the pressure may be set at a level low enough to maintain a cutting flame at torch 31, such as in the range of 20 to 40 psi.

Reactant regulator 34 may also be equipped with a mechanism for providing information about the conditions inside of the reactant tank 33, the flow into the reactant regulator 34, and the flow out of the reactant regulator 34, as shown by dials 34a and 34b. It will be appreciated that any analog or digital display may also be used.

Additionally, due to pressures in the reactant tank 34 reaching 200 pounds per square inch or higher, a reactant cap 32 capable of withstanding high pressures may be provided to enclose the valve of the reactant tank 33 while the reactant regulator 34 remains in fluid communication with the reactant tank 33. The reactant cap 32 may be threaded and adapted to fit onto an opposite thread on the reactant tank 33.

The reactant regulator 34 may be further equipped with an adapter or fitting to accommodate a reactant line 39 that is oriented in a substantially vertical alignment if a smaller overall profile is desired. A swivel connector 41 may also be incorporated to allow the reactant line 39 to be attached in fluid communication with the reactant regulator 34 without twisting the reactant line 39. A flashback arrestor 36 may further be incorporated to prevent a flame from traveling from the torch 31 up the reactant line 39 and into the reactant tank 33. The flashback arrestor 36 may be of the dry variety known to a person of ordinary skill in the art.

The reactant regulator 34 is in fluid communication with the reactant line 39 through use of a crimp fitting or other suitable mechanism. The reactant line 39 is preferably constructed of flexible and durable material, such as a medium- or high-pressure hose. A flexible hose would be of particular utility in that it could be manipulated to couple with the reactant regulator 34 without requiring the reactant regulator 34 to be oriented in any particular direction. A rigid pipe is undesirable in that it would require the reactant regulator 34 and therefore the reactant tank 33 to be precisely oriented in a specific direction.

In one particular embodiment (not shown), the reactant line 39 is directly coupled in fluid communication with a torch 31 through a threaded adapter (not shown) or other connection structure. In an alternative embodiment that will be discussed in more detail below, the reactant line 39 is fitted with a live swivel connector 51, best seen in FIG. 3, to allow the reactant line 39 to allow it to remain fluidly connected with a hose reel 26 while the hose reel 26 rotates on an axis.

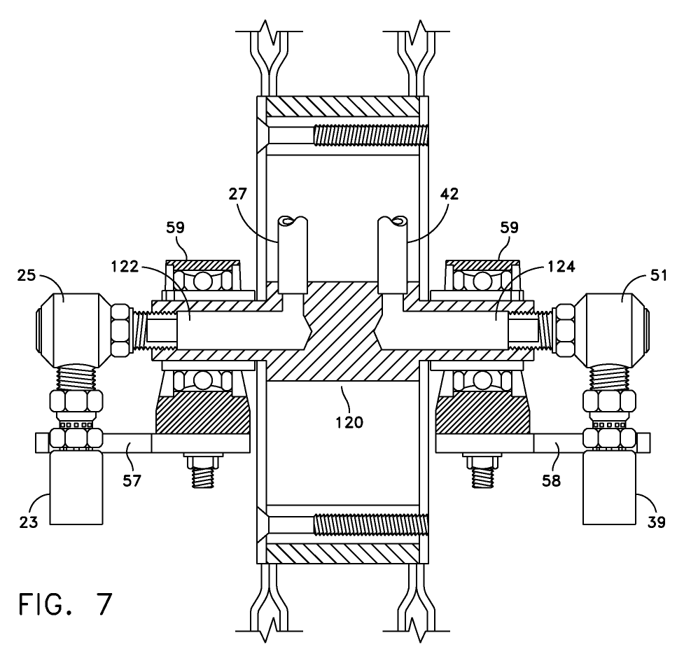

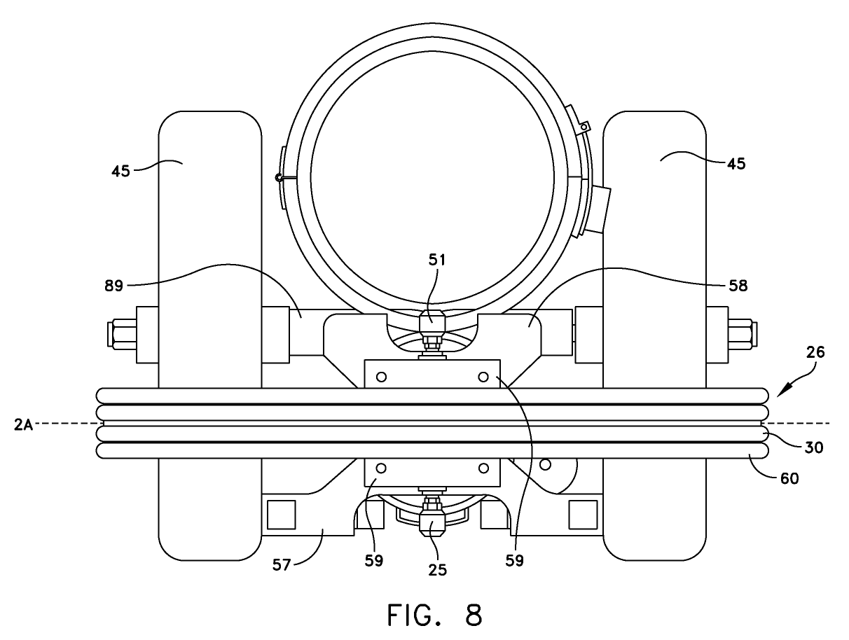

Referring to FIG. 5, the construction of one embodiment of the hose reel 26 is illustrated. The hose reel 26 is mounted on two rear reel supports 47 and two front reel supports 66. The hose reel 26 of the present embodiment has a hose reel hub 120 corresponding to its rotating axis. The hose reel 26 rotates freely on its axis due to a pillow block 59 provided on each side that engages the hose reel hub 120 which is best seen in FIG. 7. The pillow blocks 59 incorporate a ball bearing mechanism or other suitable mechanism allowing for free rotation of reel hub 120. In some embodiments rear support brackets 57 and front support brackets 58 may be employed to mount the pillow blocks 59 to the rear reel supports 47 and front reel supports 66, respectively.

Referring to FIG. 7, at opposing ends of the hose reel hub 120 are a fuel hub channel 122 and a reactant hub channel 124, which are separately enclosed channels for fuel and reactant, respectively, within the hose reel hub 120. The channels extend in a direction toward the center of the hose reel hub 120 while leaving an amount of material between them to ensure that no mixing of fuel and reactant can occur. This configuration is an improvement over systems presently in use, which typically use rubber O-rings that require regular inspection and replacement.

A threaded portion for attaching the swivel connectors 25 and 51 is provided at each end of the hose reel hub 120. The arrangement is such that the swivel connectors 25 and 51 can be connected in fluid communication with the channels in the hose reel hub 120. The swivel connectors 25 and 51 are live swivels as are known in the art, of a construction and configuration such that a portion of each is connected to the hose reel hub 120 and allowed to spin freely with the hose reel hub 120 while another portion of the swivel connectors 25 and 51 are not required to rotate. This allows swivel connector 25 to remain in fluid communication with both the fuel line 23 and the hub fuel channel 122 in the hose reel hub 120, and allows swivel connector 51 to remain in fluid communication with both the reactant line 39 the hub reactant channel 124 in the hose reel hub 120. This accomplishes the desired effect of allowing for the free flow of fuel and reactant even when the hose reel 26 is rotating. The swivel connectors 25 and 51 may be of a type similar to a 90 degree Parker series-S live swivel rated for 3000 psi, manufactured by the Parker Hannifin Corporation of Cleveland, Ohio.

The hub fuel channel 122 and reactant fuel channel 124 are in fluid communication with sections of curled hub piping 27 and 42, respectively, which may be secured to the hose reel hub 120 by welding or other joining method. The curled hub piping 27 and 42 may be of a construction and curvature so as to absorb the stresses and torque experienced when a welding hose is wrapped around the hose reel hub 120. A bushing or other adapter may be provided at the end of each section of curled hub piping 27 and 42 to allow for easy coupling and decoupling with bushings or adapters found on a standard welding hose. For example, curled hub piping 27 may be provided with an outlet bushing having a 9/16 inch, 18 threads per inch, external left-handed thread for coupling with the fuel line on standard welding hoses. Similarly, curled hub piping 42 may be provided with an outlet bushing having a 9/16 inch, 18 threads per inch, external right-handed thread for coupling with the reactant line on standard welding hoses.

Referring to FIG. 4, a welding hose 30 is provided, which in the present embodiment is a standard 50 foot type-T ¼ inch standard welding hose as is known in the art. The welding hose 30 has two separated fluid channels in communication with the fuel line 23 and the reactant line 39 through and in fluid communication with the curled hub piping 27 and 42, respectively. However, it can be appreciated that two separate hoses may also be provided, with one delivering fuel and the other delivering reactant to the torch 31. At each end of the welding hose 30 may be provided a threaded portion or other mechanism for coupling and decoupling to a fuel or reactant source or the torch 31. For example, the hose may be provided at each end with a bushing having a 9/16 inch, 18 threads per inch, internal left-handed thread known in the art for coupling with a fuel source and a fuel inlet on a torch 31, and a bushing having a 9/16 inch, 18 threads per inch, internal right-handed thread known in the art for coupling with a reactant source and a reactant inlet on a torch 31.

Turning back to FIGS. 2A and 2B, in one embodiment the hose reel 26 is further provided with a hose reel spool 48. The hose reel spool 48 can be used for coiling the welding hose 30, and should be of a material and construction durable enough to support the weight of the welding hose 30 or other possible hose configuration. The hose reel spool 48 in the present embodiment is shown in a “C” configuration, although any suitable configuration is possible. The hose reel 26 also incorporates several hose reel spokes 68 extending radially away from each end of the hose reel hub 120 in a direction perpendicular to the axis of rotation of the hose reel hub 120. The hose reel spokes 68 provide lateral support to the welding hose 30 when it is coiled around the hose reel spool 48. A pair of hose reel hoops 60 provides further lateral support for the hose reel spokes 68. Each hoop 60 is mounted to the distal end of each spoke 68.

In an embodiment having a single welding hose 30, the hose reel spokes 68 and hose reel hoops 60 on opposite sides of hose reel hub 120 may be spaced to fit only one width of welding hose 30 between them. This configuration helps to prevent kinking or twisting of the welding hose 30 when it is coiled on the hose reel spool 48. Alternatively, in an embodiment having separate hoses for delivering fuel and reactant to the torch 31, the hose reel spokes 68 and hose reel hoops 60 on opposite sides of hose reel hub 120 may be spaced to fit both hoses between them. In such a multiple hose embodiment, the hose reel 26 may be further provided with a spacer disk 93 extending outwardly from the hose reel spool 48 in a direction parallel to the hose reel spokes 68, thus allowing one hose to be stored on each side of the spacer disk 93 in order to prevent the two hoses from becoming entangled with one another or becoming kinked. This configuration is illustrated in FIG. 2B. The hose reel spool 48, hose reel spokes 68, and spacer disk 93 may be configured and spaced to allow one width of hose to fit between the spacer disk and each end of the hose reel spool 48. The spacer disk 93 is preferably of a rigid material and construction capable of withstanding lateral forces exerted on it by hoses on the hose reel spool 48. For example, the spacer disk 93 may be constructed of 16-gauge cold rolled steel.

In another embodiment, the parts described above may be made from durable materials and components rated for pressures much higher than those experienced during typical use. For example, some tanks and other components may be rated for pressures up to 3000 psi, whereas the operating pressure of the system may not typically exceed 40 psi. Pipes and conduits for gases and fuel could be joined by welding or other high-pressure fabrication or joining methods. Likewise, any flexible hoses, seals, and O-rings may be rated for temperatures well above and below those temperatures experienced during use. Rubber material that comes into contact with the fuel, for example rubber on the inside of the hoses described herein, may be made of a material that may be compatible with petroleum-based fuels, for example nitrile.

In yet another embodiment, a cart 130 is provided for improved mobility, as best seen in FIG. 3. The cart 130 and all components of the cart described below should be of a construction capable of retaining and supporting the weight of the fuel tank 62, the propellant tank 1, the reactant tank 33, and the welding hose 30, as well as other components of the system described in the several embodiments discussed above. The cart 130 may be provided with a pair of wheels 45 mounted on an axle 89. The wheels may be made of rubber and either inflatable or solid. Though axle 89 is shown as a single-piece solid axle, it can be appreciated that a differential axle or individual wheel axles may also be provided to facilitate maneuvering and turning the cart 130. The cart 130 may be provided with a handle 50 for controlling the movement of the cart 130. The handle 50 may be mounted to the rear reel supports 47, which in this embodiment may be durable enough to function as tailgate skids. A foot stand 112, in either a frame or solid configuration, may further be incorporated to provide a stable base for the cart 130 when in a stationary position.

In one embodiment, as seen in FIG. 5, a pair of support legs 64 may be rotatably mounted to cart 130. The support legs 64 may be extended through use a telescopic construction, for example, by positioning an inside member 80 within an outside member 81. Thus, when additional support is desired, for example when the system is in use in a cutting or welding application, the support legs 64 may be manipulated to extend rearwardly from the cart 130, and the inside member 80 extended from the outside member 81 and placed in contact with the ground. The inside member 80 and the outside member 81 may then be locked in relation to one another, preventing the cart 130 from accidentally toppling over.

The cart 130 may be provided with at least two reactant tank support rings 61 and 71 for retaining the reactant tank 33 in the cart 130. One or both of the reactant tank support rings 61 and 71 may be provided with a locking mechanism 73 having a hinge 74. The reactant tank 33 may thus be secured against theft or accidental displacement when the locking mechanism 73 is engaged, or the locking mechanism 73 may be disengaged with a key or other security mechanism and the hinge 74 opened to allow the tank to be removed for replacement, storage, or maintenance. The reactant tank rings 61 and 71 may be structurally mounted to the fuel tank 62 or to the cart 130.

The fuel tank 62 may be incorporated into the structure of the cart 130, or it may be mountable and dismountable with support rings similar to reactant tank support rings 61 and 71. The cart 130 may be further equipped with a pair of devises (not shown) or other mechanism for securing the system to a vehicle to facilitate transportation.

From the above descriptions of the several embodiments, it should be observed that an improved fuel delivery system for a torch has been disclosed. The system may use liquid petroleum fuel, for example gasoline, which is readily available and relatively inexpensive compared to other fuels known in the art. Since it is preferable to store gasoline at substantially ambient pressure, reactant is introduced into the fuel tank only when fuel is desired, which, as described above, forces fuel into the fuel line for delivery to the torch. This allows gasoline to be used as a fuel in welding and cutting applications without the undesirable requirement that the gasoline be stored under positive pressure.

It should further be observed that the use of swivel connectors fluidly connected to the fluid channels in the hose reel allows the hose reel to freely spin while the torch remains in fluid communication with the fuel and reactant sources. This configuration permits spooling and unspooling of the welding hose during operation of the system without requiring the welding hose to be disconnected from the fuel and reactant sources. This configuration further prevents undesirable torque from acting on the welding hose, fuel line, or reactant line, which could damage components of the system or create kinks that could prevent the free flow of fuel or reactant.

Having thus described several aspects of at least one embodiment, it should be observed that various alterations, modifications, and improvements will readily occur to those skilled in the art. Such alterations, modifications, and improvements are intended to be within the scope of this disclosure. Accordingly, the foregoing description and drawings are by way of example only, and the scope of the disclosure and embodiments should be determined from proper construction of the appended claims, and their equivalents.

What is claimed is:

1. A fuel delivery system for a torch comprising:
a first container configured to contain a reactant gas under pressure;
a second container configured to contain a combustible substance under substantially ambient pressure; and
a third container configured to contain a propellant gas under pressure, the third container being in fluid communication with the second container to selectively pressurize the second container.

2. The system of claim 1, wherein the combustible substance is gasoline and the propellant is an inert gas.

3. The system of claim 1 further comprising a hub configured to receive the reactant gas from the first container through a first line and the combustible substance from the second container through a second line.

4. The system of claim 3, wherein the hub comprise a first passage configured to receive the reactant gas from the first line and a second passage configured to receive the combustible substance from the second line.

5. The system of claim 4, wherein the first passage is separate from the second passage.

6. The system of claim 4 further comprising a torch connected to a hose, which is connected to the first and second passages of the hub.

7. The system of claim 6, wherein the hose has a first line in fluid communication with the first passage of the hub and a second line in fluid communication with the second passage of the hub.

8. A fuel delivery system for a torch comprising:
a torch;
a hose connected to and in fluid communication with the torch;
a hub connected to and in fluid communication with the hose;
a first container configured to contain a reactant gas under pressure, the first container being connected to and in fluid communication with the hub; and
a second container configured to contain a combustible substance, the second container being connected to and in fluid communication with the hub and selectively pressurized to deliver the combustible substance to the hub under pressure.

9. The system of claim 8 further comprising a third container configured to contain a propellant gas, the third container being connected to and in fluid communication with the second container.

10. The system of claim 8, wherein the propellant gas is an inert gas.

11. The system of claim 8, wherein the hub comprise a first passage connected to and in fluid communication with the reactant gas a second passage connected to and in fluid communication with the combustible substance.

12. The system of claim 11, wherein the first passage is separate from the second passage.

13. A method of delivering a reactant gas and a combustible substance to a torch, the method comprising
storing the reactant gas within a first container under pressure;
delivering the reactant gas to the torch through a first line;
storing combustible substance within a second container;
pressurizing the second container with inert fluid contained within a third container in fluid communication with the second container, the third container being configured to store the inert fluid under pressure; and
delivering the combustible substance to the torch through a second line,
wherein the rate of delivery of the combustible substance to the torch is controlled by manipulating the pressure of the third container.

14. The method of claim 13 further comprising a pressure regulator to control the pressure of the third container.

15. The method of claim 14 further comprising a pressure regulator to control the pressure of the first container.

16. A method of delivering a reactant gas and a combustible substance to a torch, the method comprising
storing the reactant gas within a first container;
delivering the reactant gas to a hub;
storing combustible substance within a second container;
delivering the combustible substance to the hub;
separating the reactant gas and the combustible gas within the hub; and
delivering the reacting gas and the combustible gas to a torch.

17. The method of claim 16 further comprising pressurizing the second container with inert fluid contained within a third container in fluid communication with the second container, the third container being configured to store the inert fluid under pressure.

18. The method of claim 17, wherein the rate of delivery of the combustible substance to the torch is controlled by manipulating the pressure of the third container.
